(19) United States
(12) Patent Application Publication
(10) Pub. No.: US 2016/0140759 A1
(43) Pub. Date: May 19, 2016

(54) AUGMENTED REALITY SECURITY FEEDS SYSTEM, METHOD AND APPARATUS

(71) Applicant: MasterCard International Incorporated, Purchase, NY (US)

(72) Inventors: Debashis Ghosh, Charlotte, NC (US); Randall Shuken, Westport, CT (US)

(21) Appl. No.: 14/540,446

(22) Filed: Nov. 13, 2014

(51) Int. Cl. G06T 19/00; G06T 7/00; G02B 27/01; G06F 17/30

(52) U.S. Cl. CPC G06T 19/006; G06F 17/30268; G06T 7/004; G02B 27/0172; G02B 2027/0178

(57) ABSTRACT

A system, method, and computer-readable storage medium configured to collect and aggregate images using augmented reality.

### BACKGROUND

1. Field of the Disclosure

Aspects of the disclosure relate in general to security and fraud prevention. Aspects include an apparatus, system, method and computer-readable storage medium to collect and aggregate images using augmented reality.

2. Description of the Related Art

Closed-circuit television (CCTV) is the use of video cameras to transmit a signal to a specific place, on a limited set of monitors. CCTV differs from broadcast television in that the signal is not openly transmitted, though it may employ point-to-point (P2P), point-to-multipoint, or mesh wireless links. Though almost all video cameras fit this definition, the term is most often applied to those used for surveillance in areas that may need monitoring such as banks, casinos, airports, military installations, and convenience stores.

CCTV equipment is often installed in commercial enterprises to prevent crime. In industrial facilities, CCTV equipment may be used to observe parts of a process from a central control room, for example when the environment is not suitable for humans. CCTV systems may operate continuously or only as required to monitor a particular event. A more advanced form of CCTV, utilizing digital video recorders (DVRs), provides recording capability. Decentralized internet protocol (IP) cameras support recording directly to network-attached storage devices, or internal flash for completely stand-alone operation. Surveillance of the public using CCTV is particularly common in many areas around the world.

Augmented reality (AR) is a live, direct or indirect, view of a physical, real-world environment whose elements are augmented (or supplemented) by computer-generated sensory input such as sound, video, graphics or GPS data. As a result, the technology functions by enhancing one's current perception of reality.

### SUMMARY

Embodiments include an apparatus, method and computer-readable medium configured to collect and aggregate images using augmented reality.

In one embodiment, an augmented reality device includes a camera, a global positioning system (GPS) antenna, a gyroscope, a processor, and a network interface. The augmented reality device records an image with the camera. the GPS antenna determines the location of the augmented reality device. The gyroscope determines a direction of the augmented reality device. The processor determines a date and time, and tags the image with the date and time, the location and the direction of the augmented reality device, resulting in a tagged image. The tagged image is transmitted to a collection server with the network interface.

A collection server embodiment comprises a network interface and a processor. The network interface receives a request. The request indicates a requested date, a requested timeframe, and a requested location. The processor searches an image index for images that match the request, resulting in matched images. The matched images are retrieved with the processor, and presented to a viewer via a display or the network interface.

### BRIEF DESCRIPTION OF THE DRAWINGS

FIG. 1 illustrates an embodiment of an apparatus to collect images for aggregation using augmented reality.

FIG. 2 illustrates a block diagram of the apparatus to collect images for aggregation using augmented reality.

FIG. 3 is a flowchart of a method to collect images for aggregation using augmented reality.

FIG. 4 illustrates a block diagram of a collection server to collect and aggregate images using augmented reality.

FIG. 5 is a flowchart of a method to collect augmented reality recorded images and store the images for aggregation.

FIG. 6 is a flowchart of a method to present collected augmented reality recorded images.

### DETAILED DESCRIPTION

One aspect of the disclosure includes the understanding that CCTV devices are limited by their fixed location.

Another aspect of the disclosure includes the realization that augmented reality devices are becoming increasingly prevalent and are able to record video, still picture, and time-lapse images. For the purposes of this disclosure, the term image encompasses video, still pictures, and time-lapse images.

Yet another aspect of the disclosure is the realization that images collected by augmented reality devices can be collected and aggregated for use in crime prevention and mitigation. Because these images can be tagged with a date, time, location and orientation of where the images were taken, the images can be collected, indexed, searched, and used for any reason that a CCTV camera footage may be used. In addition, because of the increasing number of augmented reality devices, potentially more images from different angles and directions may be collected at a lower cost than an installed CCTV camera system.

In another aspect of the disclosure, augmented reality device wearers may be encouraged to provide images through an incentive or loyalty program.

Embodiments of the present disclosure include a system, apparatus, method, and computer-readable storage medium configured to collect and aggregate images using augmented reality. In such a system, images are collected by augmented reality devices, and transmitted to a server where the images are collected, indexed, and stored for future use.

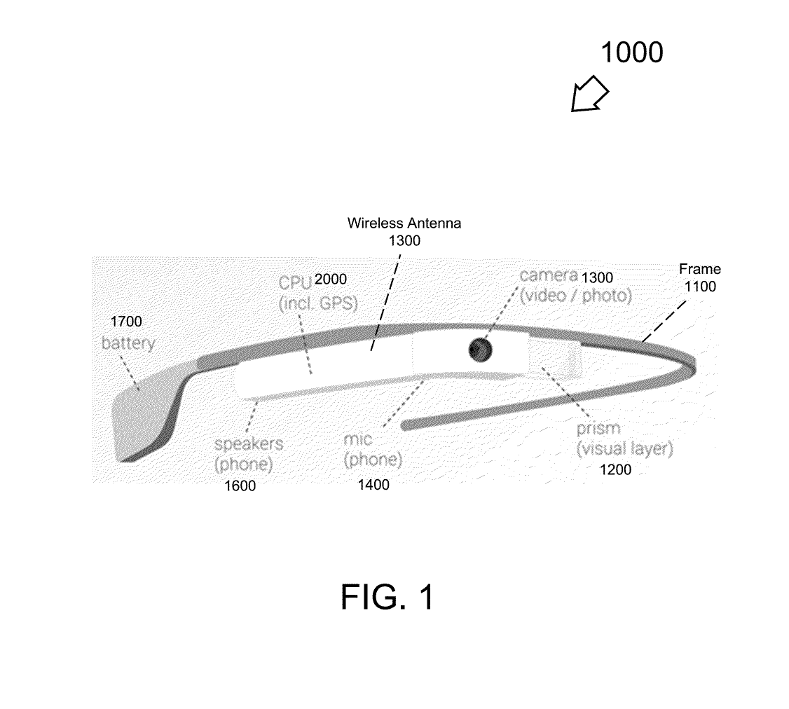

Embodiments will now be disclosed with reference to an exemplary embodiment of device 1000 of FIG. 1 configured to collect images for aggregation using augmented reality, constructed and operative in accordance with an embodiment of the present disclosure. It is understood by those familiar with the art that augmented reality devices may exist in a variety of different embodiments, including but not limited to: tablet computers, heads up displays, mobile phones, and augmented reality headsets. For the sake of example, this disclosure will describe an augmented reality headset 1000.

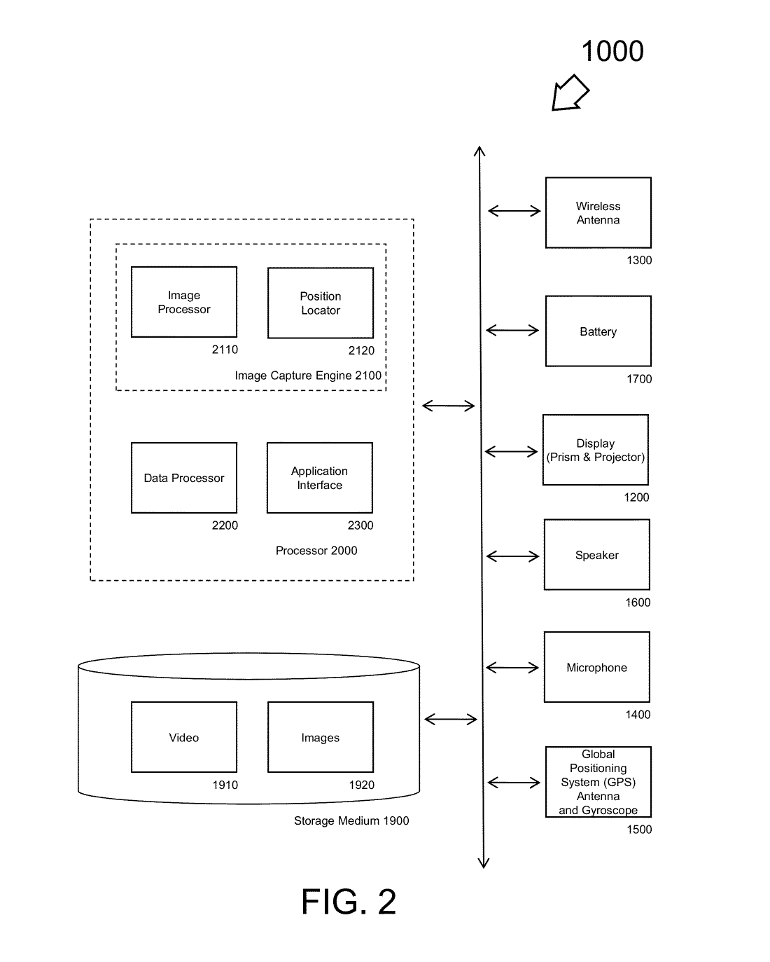

As shown in FIG. 1, the augmented reality headset 1000 includes a frame 1100. The frame may be made of a composite material, plastic, graphite, or other material known in the art. In some embodiments, frame 1100 includes touch sensors to provide touch pad functionality. Frame 1100 may house additional components, including a display (prism, visual layer) 1200, a camera 1300, microphone 1400, speakers 1600, battery 1700, global positioning system antenna and gyroscope 1500, processor 2000, storage medium 1900 and wireless antenna 1800. These components are described more fully with FIG. 2.

FIG. 2 illustrates a functional block diagram of the augmented reality headset 1000 configured to collect images for aggregation, constructed and operative in accordance with an embodiment of the present disclosure. As mentioned in FIG. 1, augmented reality headset 1000 has a frame 1100, which may house additional components.

Display 1200 provides visual information to the users. In some embodiments, the display is a piece of prism glass that allows users to see their environment, while providing a visual overlay on the environment.

Camera 1300 may be any image capture device known in the art. In some embodiments, camera 1300 may take pictures and record video that may be stored on a non-transitory computer-readable storage medium 1900 or downloaded via wireless antenna 1800.

Microphone 1400 may be any audio receiving device known in the art, including a bone conduction transducer.

Speakers 1600 may be any audio reproduction device known in the art.

Battery 1700 provides a power source to augmented reality headset 1000. In some embodiments, battery 1700 is a rechargeable lithium-ion battery.

Augmented reality headset 1000 may contain a 3-axis gyroscope, accelerometer, magnetometer (compass) and global positioning system (GPS) antenna 1500 configured to determine the location of and direction (orientation) that the user of the headset is looking at.

Storage medium 1900 may be a conventional read/write memory such as a flash memory, transistor-based memory, or other computer-readable memory device as is known in the art for storing and retrieving data.

In addition, as shown in FIG. 2, storage medium 1900 may also contain recorded video 1910, and images 1920. When present, recorded video 1910 is digital recording of data captured by camera 1300. Recorded video 1910 may also include the time, date, and location and direction of where the video was recorded. This data may be stored as meta data associated with the recorded video 1910; furthermore, recorded video 1910 may be stored in any video codec known in the art, including moving picture experts group (MPEG). In some embodiments, the recorded video 1910 may also include an audio track recorded by microphone 1400. In some embodiments, recorded video 1910 may be time lapse images. Images 1920 are still pictures taken by camera 1300, and may be in any image format known in the art, including Joint Photographic Experts Group (JPEG). Images 1920 also include the time, date, and location and direction of where the pictures were taken.

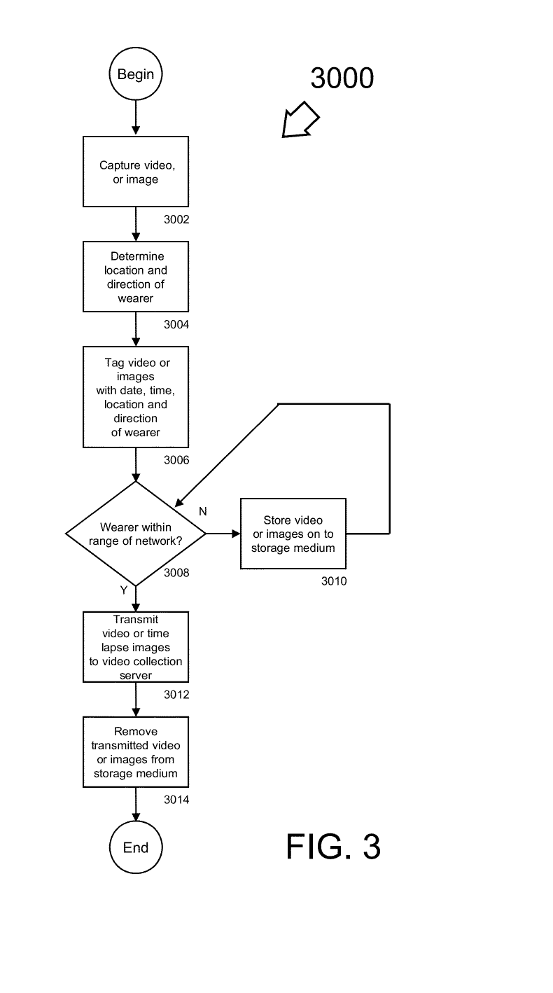

It is understood by those familiar with the art that one or more of these videos 1910 and images 1920 may be stored in any file system known in the art. In some embodiments, videos 1910 and images 1920 are stored temporarily before being uploaded to a collection server. The function of these structures may best be understood with respect to the flowcharts of FIG. 3, as described below.

Processor 2000 may be any central processing unit, microprocessor, micro-controller, computational device or circuit known in the art. It is understood that processor 2000 may temporarily store instructions and data in Random Access Memory (not shown).

As shown in FIG. 2, processor 2000 is functionally comprised of an image capture engine 2100, a data processor 2200, and application interface 2300.

An image capture engine 2100 enables the functionality for the user to record video 1910 or images 1920, and append the date, time, and position information to the video 1910 or images 1920. Image capture engine 2100 may further comprise: image processor 2110, and/or position locator 2120.

An image processor 2110 may also be referred to as an image processing engine or media processor. Image processor 2110 is a specialized digital signal processor used for image processing. In some embodiments, image processor 2110 is a system on a chip with multi-processor/multi-core processor architecture, using parallel computing even with Single Instruction, Multiple Data (SIMD) or Multiple Instruction, Multiple Data (MIMD) technologies to increase speed and efficiency. Image processor 2110 enable the processor 2000 to encode videos and images into selected data formats.

Position locator 2120 is any structure known in the art that can attach GPS location and orientation data to a video 1910 or image 1920.

Data processor 2200 enables processor 2000 to interface with storage medium 1900, wireless antenna 1800, camera 1300, battery 1700, display 1200, speaker 1600, microphone 1400, global positioning system antenna and gyroscope 1500, computer memory or any other component not on the processor 2000. The data processor 2200 enables processor 2000 to locate data on, read data from, and write data to these components.

Application interface 2300 may be any user interface known in the art to facilitate communication with the user of the augmented reality headset 1000; as such, application interface 2300 may communicate with the user via display 1200, any touch sensor or button, speaker 1600, or microphone 1400.

These structures may be implemented as hardware, firmware, or software encoded on a computer readable medium, such as storage media 1900. Further details of these components are described with their relation to method embodiments below.

Wireless antenna 1800 may be any radio frequency (RF) transceiver as is known in the art for interfacing, communicating or transferring data across a telecommunications network, computer network, Bluetooth, WiFi, near-field communications, contactless point-of-sale network, and the like. Examples of such a network include a digital cellular telephony network. Antenna 1800 allows augmented reality headset 1000 to communicate via the digital cellular telephony network to an ATM card issuer, a payment network, or other entities.

We now turn our attention to the method or process embodiments of the augmented reality device 1000 described in the flow diagram of FIG. 3. It is understood by those known in the art that instructions for such method embodiments may be stored on their respective computer-readable memory and executed by their respective processors. It is understood by those skilled in the art that other equivalent implementations can exist without departing from the spirit or claims of the disclosure.

FIG. 3 illustrates a flow chart of method 3000 to record images using augmented reality device 1000 for collection and review by a collection server, constructed and operative in accordance with an embodiment of the present disclosure.

Initially, at block 3002, camera 1300 captures a video 1910 or an image 1920.

Based on information provided by global positioning system antenna and gyroscope 1500, position locator 2120 determines the location and orientation/direction of the augmented reality device 1000 when the video 1910 or image 1920 was taken, block 3004.

Based on the determined location and direction information, position locator 2120 tags the video 1910 or images 1920, block 3006. In some embodiments, the video or image codec's may allow GPS location and orientation information to be stored in the video or image file as metadata. In other embodiments, the GPS location and orientation information is placed in a separate file linked or otherwise associated with the video or image files.

In yet other embodiments, the image may also be tagged with an origination identifier that labels the wearer or augmented reality device 1000 that took the image. In such embodiments, this information may be provided to future viewers of the images as part of an incentive program to reward wearers of the augmented reality device 1000 for taking the image.

The augmented reality device 1000 will wait to upload the captured video 1910 or images 1920 when in the range of wireless network, determined at block 3008. In some embodiments, the augmented reality device 1000 uploads when customers have opted into the service. Customers may be incentives do opt into the service with promotional offers such as discounts and electronic coupons.

When the augmented reality device 1000 is not in range of a wireless network, as determined at decision block 3008, the video 1910 or images 1920 are stored on to storage medium 3010, block 1900. When the augmented reality device 1000 is in range of a wireless network, as determined at decision block 3008, the video 1910 or images 1920 are uploaded to the collection server, block 3012. In some embodiments, video 1910 or images 1920 is uploaded when the augmented reality device 1000 is in communication range of a digital wireless telephony network; in other embodiments, the augmented reality device 1000 will favor uploads via Wireless Local Area Networks (WLAN), such as wireless networks based on the Institute of Electrical and Electronics Engineers' (IEEE) 802.11 standards commonly referred to as “Wi-Fi.”

After the video 1910 or images 1920 are uploaded, they may be removed from the storage medium 1900, block 3014. Process 3000 then ends.

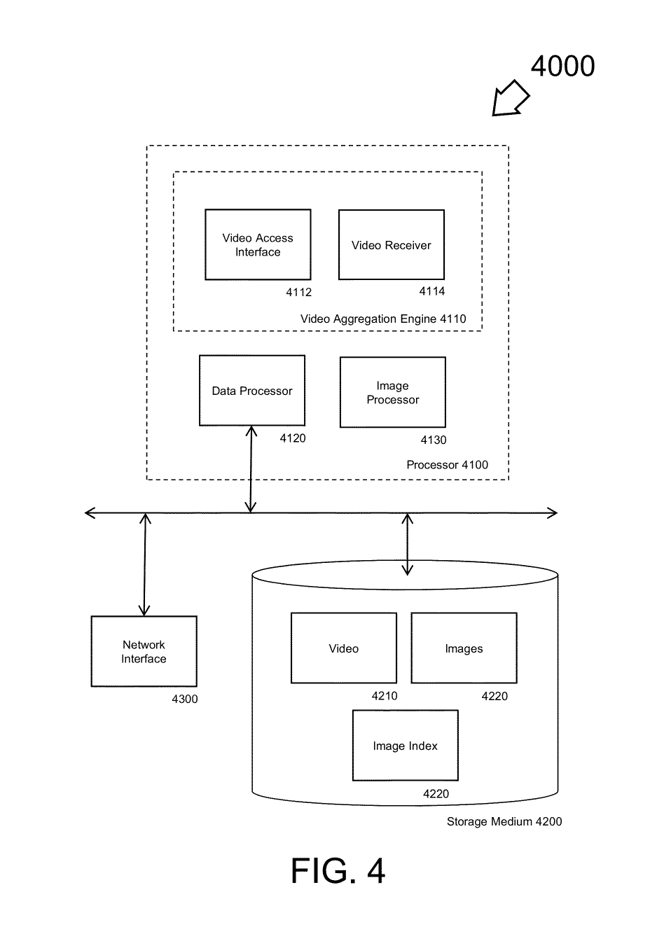

FIG. 4 illustrates a block diagram of a collection server 4000 configured to collect and aggregate images captured by an augmented reality device 1000, constructed and operative in accordance with an embodiment of the present disclosure.

Collection server 4000 may run a multi-tasking operating system (OS) and include at least one processor or central processing unit (CPU) 4010, a non-transitory computer-readable storage media 4200, and a network interface 4300.

Processor 4100 may be any central processing unit, microprocessor, micro-controller, computational device or circuit known in the art. It is understood that processor 4100 may temporarily store data and instructions in a Random Access Memory (RAM) (not shown), as is known in the art.

As shown in FIG. 4, processor 4100 is functionally comprised of a video aggregation engine 4110, image processor 4130, and a data processor 4130.

Video aggregation engine 4110 is the structure that receives and processes videos 1910 and images 1920 transmitted from augmented reality device 1000. It is understood that the videos 1910 and images 1920 are further received via a network interface 4300.

Video receiver 4114 is the interface within video aggregation engine 4110 that processes the received videos 1910 and images 1920, ultimately storing the video 4210 and images 4220 on a storage media 4200. Video receiver 4114 may also create an image index 4220 of the video 4210 and image 4220 data. The image index 4220 allows a video access interface 4112 to retrieve selected videos 4210 and images 4220 quickly and efficiently.

Video access interface 4112 is the interface which enables users to access collected videos 4120 and images 4220 which have been collected by the collection server 4000. In some embodiments, video access interface 4112 is a World Wide Web (“WWW” or “web”) interface including a web-server that facilitates user access via the Internet, Wide Area Network (WAN), or private computer network.

Data processor 4130 interfaces with storage media 4200 and network interface 4300. The data processor 4130 enables processor 4100 to locate data on, read data from, and writes data to, these components.

Image processor 4130 enables the processor 4000 to process videos and image data formats. Image processor 4130 may be a specialized digital signal processor used for image processing. In some embodiments, image processor 4130 is a system on a chip with multi-processor/multi-core processor architecture, using parallel computing even with SIMD or MIMD technologies to increase speed and efficiency.

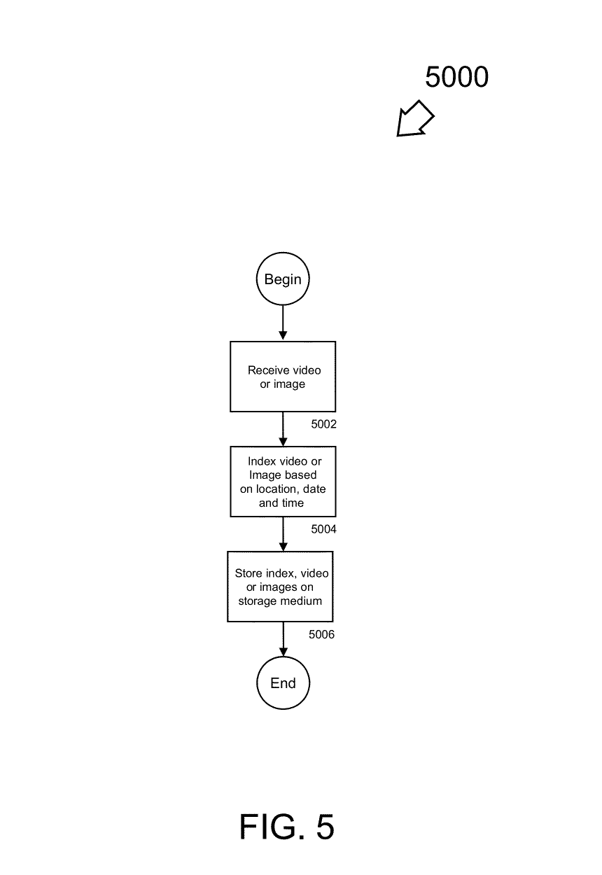

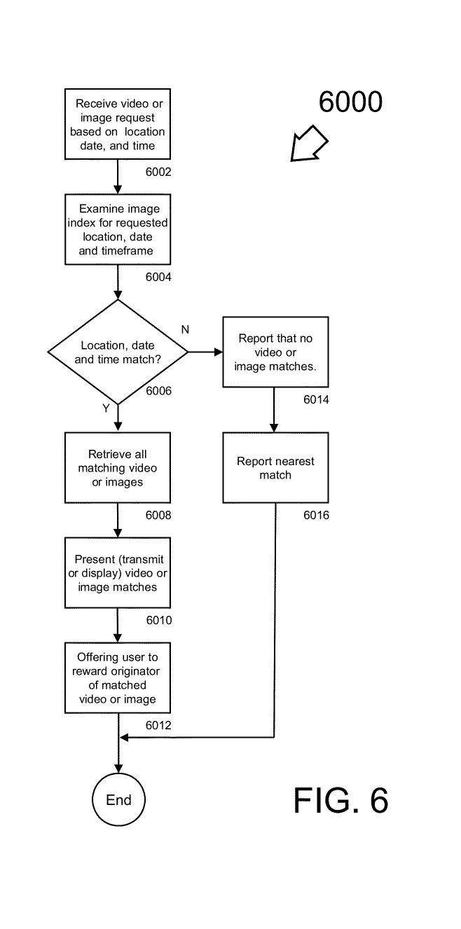

The functionality of all these structures is elaborated in greater detail in FIGS. 5 and 6. These structures may be implemented as hardware, firmware, or software encoded on a computer readable medium, such as storage media 4200. Further details of these components are described with their relation to method embodiments below.

Non-transitory computer-readable storage media 4200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage media 4200 may be remotely located from processor 4100, and be connected to processor 4100 via a network such as a local area network (LAN), a wide area network (WAN), or the Internet.

In addition, as shown in FIG. 4, storage media 4200 may also videos 4210, images 4220 and an image index 4220.

Network interface 4300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 4300 allows collection server 4000 to communicate with merchant 1200 and issuer 1400.

The method or process embodiments of the collection server 4000 are described in the flow diagrams of FIGS. 5 and 6. FIG. 5 depicts a method to collect augmented reality recorded images and store the images for aggregation, while FIG. 6 is a flowchart of a method to present collected augmented reality recorded images.

FIG. 5 illustrates a flow chart of method 5000 performed by a collection server 4000 to collect augmented reality recorded images and store the images for aggregation, constructed and operative in accordance with an embodiment of the present disclosure.

Initially, at block 5002, the network interface 4300 receives video 1910 or images 1920 from the augmented reality device 1000. In some embodiments, image processor 4130 may re-encode the video or image data into another video or image format

Video receiver 4114 indexes the video 1910 or images 1920 based on the location, date and time stamp of when the video or images were captured by augmented reality device 1000, block 5004. Note that generally the orientation of the video 1910 or images 1920 may not be indexed, but may the orientation data is retained to provide future viewers direction context.

The index, video/images are stored on storage media 4200, block 5006.

FIG. 6 is a flowchart of a method to present collected augmented reality recorded images, constructed and operative in accordance with an embodiment of the present disclosure.

At block 6002, the video access interface 4112, via the network interface 4300, receives a search request based on location, date and timeframe of desired video or images.

The video access interface 4112 examines the image index 4220 for images that match the requested location, date and timeframe.

When videos or images match the requested location, date and timeframe, as determined by the video access interface 4112 at decision block 6006, the matching videos 4210 or images 4220 are retrieved at block 6008; these matching videos 4210 or images 4220 are either transmitted to a user computer or displayed locally on a display, block 6010. The direction/orientation of the matching videos 4210 or images 4220 may also be provided to users, providing context.

In some embodiments, the user is presented with an opportunity to reward the person or entity that took the relevant image, block 6012. In such an embodiment, the image may have been tagged with an origination identifier that labels the wearer or augmented reality device 1000 that took the image. This information may be provided to users as part of an incentive program to allow users to reward wearers of the augmented reality device 1000 for taking the image. Rewards may come in the form of a cash incentive, loyalty points (such as frequent flier miles/points, hotel loyalty points or other loyalty currency system known in the art), and the like. In yet other embodiments, the wearer may automatically be rewarded for a viewed image or for providing the image.

When no videos or images match the requested location, date and timeframe, as determined by the video access interface 4112 at decision block 6006, video access interface 4112 reports that there are no matched videos or images, block 6014. In some embodiments, nearest matches are reported, block 6016. Nearest matches may be matches to a wider search, such as a match at a similar timeframe in a nearby location.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. An augmented reality device method comprising:
recording an image with a camera;
determining a location of the augmented reality device via a global positioning system (GPS) antenna;
determining a direction of the augmented reality device via a gyroscope;
determining a date and time with a processor;
tagging the image with the date and time, the location and the direction of the augmented reality device with the processor, resulting in a tagged image;
transmitting the tagged image to a collection server with a network interface.

2. The augmented reality device method of claim 1, wherein the image is either a video, a still picture, or a time-lapse image.

3. The augmented reality device method of claim 2, further comprising:
tagging the image with an origination identifier.

4. The augmented reality device method of claim 3, further comprising:
transmitting the origination identifier with the tagged image.

5. The augmented reality device method of claim 4, wherein the origination identifier identifies either the augmented reality device or a user of the augmented reality device.

6. A collection server method comprising:
receiving a request with a network interface, the request indicating a requested date, a requested timeframe, and a requested location;
searching an image index for images that match the request with a processor, resulting in matched images;
retrieving the matched images with the processor;
presenting the matched images to a viewer via a display or the network interface.

7. The collection server method of claim 6, further comprising:
presenting an orientation of an augmented reality device with the matched images.

8. The collection server method of claim 7, wherein the matched images are associated with an originator identifier that identify either the augmented reality device or a wearer of the augmented reality device.

9. The collection server method of claim 8, further comprising:
providing the viewer an opportunity to reward the wearer of the augmented reality device.

10. The collection server method of claim 9, wherein the matched image is either a video, a still picture, or a time-lapse image.
